(19) United States
(12) Patent Application Publication
(10) Pub. No.: US 2020/0259720 A1
(43) Pub. Date: Aug. 13, 2020

(54) System And Method For Enhancing Efficiency Of An Enterprise Network Via Electronic Currency Communication Within The Enterprise Network

(71) Applicant: BOOZ ALLEN HAMILTON INC., McLean, VA (US)

(72) Inventors: Mark Becker, Vienna, VA (US); Paul-Sung Hong, Alexandria, VA (US); Matthew E. Lee, Gaithersburg, MD (US)

(73) Assignee: BOOZ ALLEN HAMILTON INC., McLean, VA (US)

(21) Appl. No.: 16/274,996

(22) Filed: Feb. 13, 2019

(51) Int. Cl. H04L 12/24; G06Q 20/06; G06Q 10/06

(52) U.S. Cl. CPC H04L 41/5029; G06Q 10/06315; H04L 41/5096; G06Q 20/0658

(57) ABSTRACT

A system for enhancing efficiency of an enterprise network via electronic currency communication within the enterprise network. The system can include a first client computer configured to create a first electronic message, and a transaction database configured to store electronic currency. The system can include a server to receive the first electronic message from the first client computer, wherein the server includes an assessment module and an embedding module. The system can include a second client computer to receive the first electronic message containing the metadata from the server, parse the first electronic message containing the metadata to obtain an offer associated with the executable task, and determine whether to accept the offer. The server can include a reallocation module to reallocate network resources based on first client computer behavior data, second client computer behavior data, timestamp data, network topology data, network transactions data, network traffic data.

### FIELD

The present disclosure relates to a system and method for enhancing efficiency of an enterprise network via electronic currency communication within the enterprise network.

### BACKGROUND INFORMATION

The prosperity of enterprises and organizations can depend upon how efficiently they can complete large scale projects with limited network resources. Such projects may include creating and debugging a computer software application, conducting a research project, fabricating a satellite, or a myriad other such endeavors.

Enterprises are involved with customers, suppliers, partners, and others, and have a limited number of computer network resources to process all of the incoming information and tasks in a timely manner. Enterprises continually strive to improve their performance by efficiently managing their resources, including for example, network resources.

Known management tools includes tools for project planning, scheduling, developing a product, managing financial and capital resources and monitoring progress. These known project management tools provide limited capabilities for prioritizing tasks to be completed by team members and have no mechanism for adapting to circumstances of network resources when scheduling and prioritizing project tasks. This can lead to project impediments, delays, additional cost, and adverse operational consequences that impede timely completion of tasks.

Aspects of the present disclosure present technical solutions to address the previously described technical problems that may arise with limited network resources.

### SUMMARY

A system for assessing task priority via electronic currency communication within a network is disclosed. The system can include a first client computer configured to create a first electronic message, wherein the first electronic message includes at least a task offer amount and one or more task attributes of an executable task; a transaction database configured to store electronic currency; a server configured to receive the first electronic message from the first client computer, wherein the server includes an assessment module and a embedding module, the assessment module being configured to perform an assessment as to whether there is an available balance of the electronic currency for the task offer amount by accessing the transaction database, and the embedding module being configured to embed the task attributes or the task offer amount as metadata in the first electronic message, based on the assessment of the available balance of the electronic currency; a second client computer configured to receive the first electronic message containing the metadata from the server, parse the first electronic message containing the metadata to obtain an offer associated with the executable task, and determine whether to accept the offer, wherein the server includes a reallocation module configured to reallocate network resources based on at least one of first client computer behavior data, second client computer behavior data, timestamp data, network topology data, network transactions data, network traffic data to enhance the efficiency of the enterprise network.

A computerized method for assessing task priority via electronic currency communication within a network is disclosed. The method can include creating a first electronic message at a first client computer, wherein the first electronic message includes at least a task offer amount and one or more task attributes of an executable task; storing electronic currency at a transaction database by the first client computer; transmitting the first electronic message from the first client computer to a server; performing, at the server, an assessment as to whether there is an available balance of the electronic currency for the task offer amount by accessing the transaction database; embedding, at the server, the task attributes or the task offer amount as metadata in the first electronic message, based on the assessment of the available balance of the electronic currency; transmitting the first electronic message containing the metadata to a second client computer; parsing, at the second client computer, the first electronic message containing the metadata to obtain an offer associated with the executable task and determine whether to accept the offer; and reallocating, by the server, network resources based on at least one of first client computer behavior data, second client computer behavior data, timestamp data, network topology data, network transactions data, or network traffic data to enhance the efficiency of the enterprise network.

### BRIEF DESCRIPTION OF THE DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 is an exemplary system diagram for enhancing efficiency of an enterprise network via electronic currency communication within the enterprise network;

FIG. 2 is an exemplary flow chart for assessing task priority via electronic currency communication within a network;

FIG. 3 is an exemplary detailed flow chart for creating an offer;

FIG. 4 is an exemplary detailed flow chart for considering an offer;

FIG. 5 is an exemplary detailed flow chart for re-considering an offer;

FIG. 6 is an exemplary detailed flow chart for performing an executable task; and

FIG. 7 is an exemplary detailed flow chart for finalizing a transaction.

### DETAILED DESCRIPTION

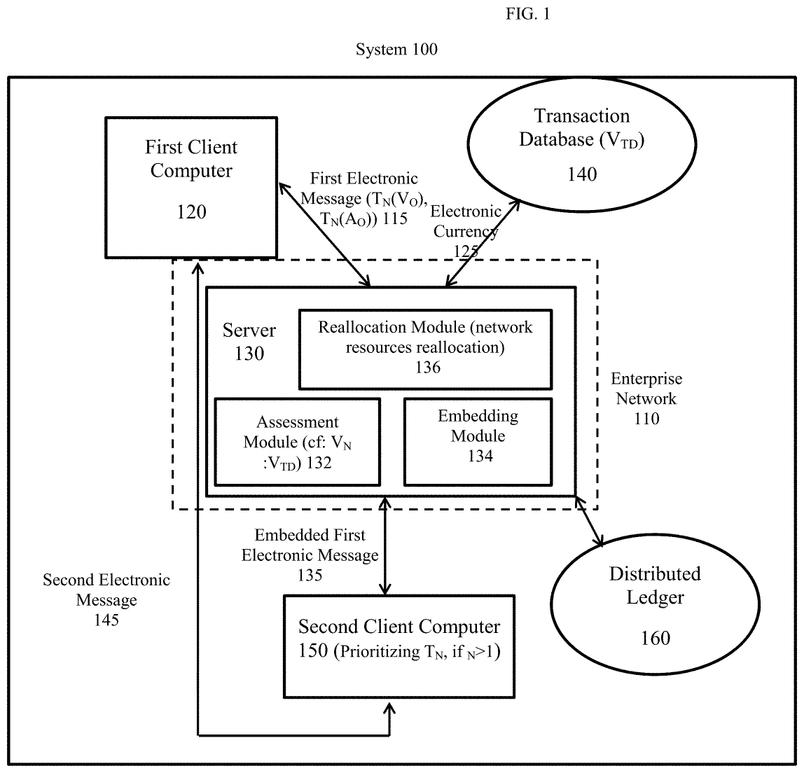

FIG. 1 illustrates a system 100 for enhancing efficiency of an enterprise network via electronic currency communication within the enterprise network. A network, as used herein, can be a computer network, a data network, or a digital telecommunications network. The network can allow nodes operating in the network to share resources with each other using connections (data links) between nodes. These data links can be established over cable media such as wires or optic cables, or wireless media such as WiFi.

Electronic currency, or electronic money, is a type of unregulated, digital money, which is issued and usually controlled by its developers and used and accepted among the members of a community. Electronic currency can be available in digital form (in contrast to physical form, such as banknotes and coins). It exhibits properties similar to physical currencies, but can allow for instantaneous transactions and borderless transfer-of-ownership.

Electronic currencies can be “closed” or “fictional currency” when they have no official connection to the real economy. Electronic currencies can be a representation of an individual's opinion on the value of something, or a representation of the worth an individual assigns to something.

Electronic currencies can be akin to a coupon or a reward within an environment. For example, currencies in multiplayer online role-play games such as World of Warcraft, customer incentive programs or loyalty programs such as frequent flyer programs by various airlines, Microsoft Points, Nintendo Points, Facebook Credits and Amazon Coin.

In an exemplary embodiment, an executable task may be an action that is to be performed by a user or an electronic system, or any equivalents thereof Alternately, a task may be a piece of data that must be acted upon in some fashion, for example a news item received by a news service or a piece of intelligence data received by an intelligence gathering organization.

In an exemplary embodiment, task prioritization can arrange items or activities in order of importance relative to each other. Priority setting can be influenced by time, money, importance and expertise among other factors that can be specific to an organization.

In an exemplary embodiment, electronic currency communication can include transacting electronic currency in a secure manner over an enterprise network 110 between various components of the system 100. Secure communication can be achieved by encryption, cryptography, steganography, or any equivalents thereof, as explained in detail later herein.

In an exemplary embodiment, the system 100 can include a first client computer 120 configured to create a first electronic message 115. The first client computer 120 can be computer hardware or software that accesses a service made available by a server 130. The server 130 can be within the first client computer 120 and/or the second client computer 150. Alternately, the server 130 can be on one or more nodes of the network 110, as shown in FIG. 1, or external to the network 110. The server 130 can be accessed by the first client computer 120 by way of a network that allows for network nodes to communicate with each other.

In an exemplary embodiment, the first electronic message 115 can include at least a task offer amount, and one or more task attributes of an executable task. The task offer amount can be a value of an electronic currency that the first client computer 120 is willing to offer for execution of a task. The one or more task attributes can include, but are not limited to, task category, assignment information (e.g. assignee, and assignor information), schedule information (e.g. start and end dates), staffing and cost information, related task information, exchange rate information for exchange between an electronic currency and any other currency, or any equivalents thereof.

In an exemplary embodiment, the system 100 can include a transaction database 140 configured to store electronic currency 125. The transaction database 140 can be based on one or more nodes of the network 110, as shown in FIG. 1. Alternatively, the transaction database 140 can be based on a device external to the network 110.

In an exemplary embodiment, the server 130 can be configured to receive the first electronic message 115 from the first client computer 120. The server 130 can include an assessment module 132 that can be configured to perform an assessment as to whether there is an available balance of the electronic currency 125 for the task offer amount by accessing the transaction database 140. The server 130 can include an embedding module 134 that can be configured to embed the task attributes or the task offer amount as metadata in the first electronic message 115 when generating the first electronic message containing the metadata 135, based on the assessment of the available balance of the electronic currency 125.

In an exemplary embodiment, metadata in the form of the task attributes or the task offer amount can be embedded with the first electronic message 115 to create a file, such as an image file, that includes both the first electronic message and the embedded metadata. The embedded metadata can include an instruction that directs the receiving application to perform a variety of tasks upon receiving and/or opening the message and accessing the content. For instance, the metadata can specify that upon receiving or selecting the file, the receiving computing device open a webpage associated with a task, estimate a completion date of the task, and input a corresponding due date for completing the task.

In an exemplary embodiment, the first electronic message containing the metadata 135 can visually indicate to a user that it includes an embedded metadata specifying execution of one or more sub-tasks. For instance, the first electronic message containing the metadata 135 may include an icon (e.g., a star and/or an emoji) that indicates the image includes metadata specifying performance of a particular task or sub-task (e.g., performing software code testing). This will make a user aware that the image or other content may cause performance of the task or sub-task associated with the image or other content.

In an exemplary embodiment, the system 100 can include a second client computer 150 configured to receive the first electronic message containing the metadata 135 from the server 130, parse the first electronic message containing the metadata 135 to obtain an offer associated with the executable task, and determine whether to accept or decline the offer.

The communication between network nodes of the network 110 can include a secure electronic currency communication. For example, communication between the first client computer 120, the second client computer 150, or the server 130 can include a secure electronic currency communication that can be achieved by encryption, cryptography, steganography, or any equivalents thereof.

In an exemplary embodiment, the secure electronic currency communication can be achieved by encryption. Encryption can involve encoding a message or information in such a way that only authorized parties can access it and those who are not authorized cannot, thereby, denying the intelligible content to a would-be interceptor. In an encryption scheme, the intended information or message (plaintext) can be encrypted using an encryption algorithm—e.g. a cipher—generating ciphertext that can be read only if decrypted. The encryption scheme can use a pseudo-random encryption key generated by an algorithm. An authorized recipient can easily decrypt the message with the key provided by the originator to recipients but not to unauthorized users.

In an exemplary embodiment, the secure electronic currency communication can be achieved by cryptography (e.g. Symmetric-key cryptography or Public-key cryptography). Cryptography can involve encryption methods in which both the sender and receiver share the same key, or in which their keys are different, but related in an easily computable way. Cryptography can involve encryption methods that use the same key for encryption and decryption of a message, although a message or group of messages can have a different key than others.

In an exemplary embodiment, the secure electronic currency communication can be achieved by steganography. Steganography can involve concealing a file, message, image, or video within another file, message, image, or video. For example, concealing the task offer attributes and task offer amount in electronic messages communicated between the nodes (e.g. the first client computer 120, the second client computer 150, or the server 130) of the network 110. The electronic messages may include steganography coding inside of a transport layer, such as a document file, image file, program or protocol. For example, the first client computer 120 can start with an innocuous image file with task information, and adjust the color of every hundredth pixel to correspond to a letter in the alphabet. The change can be so subtle that someone who is not specifically looking for it (e.g. an unauthorized user) is unlikely to notice the change.

In an exemplary embodiment, the secure electronic currency communication can include any sort of action that is external to the first electronic message containing the metadata 135 and/or rendering of the first electronic message 135. These actions may include, for instance, displaying content in addition to an image of the first electronic message 135, opening up a page associated with a Uniform Resource Locator (URL) address specified by the metadata, selecting a link (embedded within the image) to an executable file or an application, executing code or script embedded within the image or any other action that is external to the image of the image file. In some instances, the format of the embedded metadata can include a standard format that may be read by a variety of applications. As such, the first electronic message 135 can include the image and the embedded metadata can include a file that is application independent.

In an exemplary embodiment, the server 130 includes a reallocation module 136 that can be configured to reallocate network resources based on at least one of first client computer behavior data, second client computer behavior data, timestamp data, network topology data, network transactions data, or network traffic data to enhance the efficiency of the enterprise network.

In an exemplary embodiment, the first client computer behavior data includes at least one of utility information that indicates utility of the task offer amount for the first client computer 120, motivation information that indicates a preference of the task attributes for the first client computer 120, or priority information that indicates a priority of the first client computer 120 for transmitting a request for the executable task in relation to transmitting requests for other tasks. For example, if the first client computer 120 offers amount N of the electronic currency to complete an executable task, N can reflect the utility of the executable task from the perspective of the first client computer 120.

In an exemplary embodiment, the second client computer behavior data can include at least one of utility information that indicates utility of the task offer amount for the second client computer, motivation information that indicates a preference of the task attributes for the second client computer 150, or priority information that indicates a priority of the second client computer 150 for performing the executable task in relation to performing other tasks.

For example, if the second client computer 150 accepts the amount N of the virtual currency for an offer made by the first client computer 120, this acceptance can show that the utility of the task for the second client computer 150 can be higher than or equal to N. Alternately, if the second client computer 150 rejects the amount N of the virtual currency for an offer made by the first client computer 120, this rejection can show that the utility of the task for the second client computer 150 can be lower than N. The utility can be used in the game theoretical sense as it reflects motivations, or priorities, assessed by a client computer. This method of measuring utility to different network resources is useful for an organization since it represents uncensored motivations and priorities of network resources, such as client computers or employees that operate the client computers.

In an exemplary embodiment, the timestamp data can include, but is not limited to, at least one of: the time the first electronic message was created, the time the server received the first electronic message, the time the second client computer received the first electronic message containing the metadata, the time the second client computer determined whether to accept the offer, or the time the executable task was completed.

For example, if the first client computer 120 makes an offer to the second client computer 150 at time t_0, the second client computer 150 accepts the offer at time t_1, completes the task at time t_2, and the first client computer 120 finalizes the transaction at time t_3. Then, the value (t_1−t_0) can be the response time of the offer-acceptance transaction, the value (t_2−t_1) can be the time to execute and complete the task, the value (t_3−t_2) can be the approval time. These values are first order measurements that can be useful for an enterprise to chart transaction efficiency.

In an exemplary embodiment, the network topology data can include a physical arrangement (topology) of the first client computer 120, the second client computer 150, and the server 130, and a logical arrangement for data flow between the first client computer 120, the second client computer 150 and the server 130. The physical arrangement can be determined by the capabilities of the network access devices and media, the level of control or fault tolerance desired, and the cost associated with cabling or telecommunications circuits. The logical arrangement can include, but is not limited to, ring, mesh, star, fully connected, line, tree, or bus topology.

In an exemplary embodiment, the network's logical topology can be different from its physical topology. For example, the twisted pair Ethernet using repeater hubs as logical bus topology can be carried on a physical star topology. Token ring is a logical ring topology, but can be wired as a physical star from the media access unit.

In an exemplary embodiment, the network graph data can show an underlying topology of transactions within the enterprise network. For example, set G=(V, E), where V is a non-empty set of nodes, and E is a set of directed edges, can form a directed graph. The set V can be determined by users (client computers) in the network. The set E can reflect each transaction between two users, (e.g., first client computer 120 and second client computer 150), which are nodes in set V. The graph theoretical notation can provide metrics that define the topology. For example, weighted graphs can be formed by assigning a numerical value N (the amount of a transaction) to the edge representing the transaction. Weighted graphs are representations that can be analyzed to solve hard problems such as the traveling salesman problem and other shortest path problems.

In an exemplary embodiment, the network transactions data can include probability distribution statistics based on transactions among the first client computer 120, the second client computer 150, and the server 130. The probability distribution statistic can be based on a distribution of tasks related to large numbers of transactions in the network, the rate at which the internal virtual currency passes from one user to another, which can be computed from first order metrics on transactions. The network transactions data can be useful for an enterprise to optimize and prioritize the network traffic.

In an exemplary embodiment, the network traffic data can include a rate of data flow among the first client computer 120, the second client computer 150, and the server 130 at a specific time. The traffic data can indicate particularly busy or slow periods for the network as a whole or in parts. For example, the set {T_i, where each T_i is a unique transaction of all transactions 1 through k over some fixed time} can be used to compute a distribution of transactions, illustrating low/high periods. This data is useful for companies to plan for low/high periods of activity, so they can reallocate resources and avoid bottlenecks and other undesirable consequences. All the previously described metrics can be computed for some fixed time interval T_0 and compared with another time interval T_1 to determine differences, correlations, or other phenomena derived from new currency introduced into the systems or stimulus efforts directed by the administrators of the system. The network traffic data can include network projections. For example, network resources might be proactively adjusted to anticipate expected future volumes at certain nodes

In an exemplary embodiment, the system 100 can include a distributed ledger 160 configured to record information regarding the task offer amount, the task attributes, and timestamp information. The distributed ledger 160 can be configured to record one or more of the first client computer behavior data, the second client computer behavior data, the timestamp data, the network topology data, the network transactions data, or the network traffic data. Alternately, a memory can be used to record this information.

In an exemplary embodiment, the distributed ledger 160 (also called a shared ledger, or distributed ledger technology, “DLT”), can be a consensus of replicated, shared, and synchronized digital data geographically spread across multiple sites, countries, or institutions. Therefore, in an exemplary embodiment, there may be no central administrator or centralized data storage of the distributed ledger 160.

In an exemplary embodiment, the distributed ledger 160 can be implemented on a peer-to-peer network and may require consensus algorithms to ensure replication across nodes is undertaken. One form of distributed ledger design is the blockchain system, which can be either public or private. In an exemplary embodiment, a blockchain can be one type of data structure considered to be the distributed ledger 160.

In an exemplary embodiment, the distributed ledger 160 can be configured on one or more devices located within the network 110. For instance, the distributed ledger 160 can be configured on the first client computer 120, the server 130, the second client computer 150, or any combination thereof. The distributed ledger 160 can be configured on one or more devices located external to the network 110.

In an exemplary embodiment, the distributed ledger 160 can manage one or more aspects of the electronic currency 125. For example, transactions among various nodes of the system 100 and network 110 can be recorded on the distributed ledger 160. Such transactions can include, but are not limited to, payment between various nodes, issuing new assets to various nodes, or using escrow accounts, or any equivalents thereof. This can ensure data integrity because the append-only aspect of the distributed ledger 160 does not allow the nodes to modify past transactions.

In an exemplary embodiment, the distributed ledger 160 can be configured on different types of memory that can be any computer-readable medium. The term “computer-readable medium” (or “machine-readable medium”) as used herein is an extensible term that refers to any medium or any memory, that participates in providing instructions to a processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, and transmission media.

Transmission media can include coaxial cables, copper wire or fiber optics, including the wires comprising any bus. Transmission media can also take the form of acoustic or light waves, such as those generated during radio-wave and infrared data communications, or other form of propagated signals (e.g., carrier waves, infrared signals, digital signals, etc.). Forms of computer-readable media include, for example, floppy disks, flexible disks, hard disks, magnetic tape, or any other magnetic medium, CD-ROM or any other optical medium, punch-cards, paper-tape, or any other physical medium with patterns of holes, RAM, PROM, EPROM, FLASH-EPROM, or any other memory chip or cartridge, carrier waves as described hereinafter, or any other medium from which a computer can read.

In an exemplary embodiment, the second client computer 140 can be configured when the second client computer 150 accepts the offer to transmit a second electronic message 145 to the first client computer 120 upon completion of the executable task. The second electronic message 145 can go via the server 130, or directly from the first client computer 120 to the second client computer 150, as shown in FIG. 1.

In an exemplary embodiment, the first client computer 120 can be configured to rate the completion of the executable task, when the second electronic message 145 is received by the first client computer 120. The rating can be performed on a graphic rating scale or any equivalents thereof, which indicates the rating options on a scale of 1-3, 1-5, etc. (e.g., a Likert Scale). The first client computer 120 can select a rating that is depicted on a line or scale.

In an exemplary embodiment, the rating can be performed on a numerical rating scale, or any equivalents thereof, that can have numbers as rating options and not each number corresponds to a characteristic or meaning that reflects a relative trend, positive or negative, strength or weakness, or like or dislike, etc. in relationship to other numbers in the numerical rating scale.

In an exemplary embodiment, the rating can be performed on a descriptive rating scale, or any equivalents thereof, such that each rating option is explained for the respondents. A numerical value is not always related to the answer options in the descriptive rating scale. Examples of a descriptive rating scale can include a customer satisfaction survey, which needs to describe all the rating options in detail so that every customer is provided thorough explanations of what each rating option means.

In an exemplary embodiment, the rating can be performed on a comparative rating scale, or any equivalents thereof, which can have the first client computer 120 answer a particular question in terms of comparison.

In an exemplary embodiment, the server 130 can be configured to generate data based on the information recorded on the distributed ledger 160. The data generated by the server 130 can be in the form of a report to be displayed on a display monitor (e.g., LCD screen, plasma screen, LED screen, DLP screen, CRT screen, etc.). The report can be formed by integrating information received from the distributed ledger 160. The data can be generated automatically, without any user input. Alternately, the data can be generated only after a user input.

In an exemplary embodiment, the first client computer 120 can be configured to launch an electronic application to modify the task attributes by selecting or changing a due date for completing the task.

In an exemplary embodiment, the electronic application can be launched in a snap-shot view which brings together, in one summary window, a limited list of common functions (e.g., selecting a due date) and commonly accessed data which can otherwise be reached directly from a main menu listing some or all applications.

In an exemplary embodiment, the server 130 can be configured to terminate the task offer when the available balance is less than the task offer amount. The server 130 can be configured to terminate the task offer when the second client computer 150 rejects the task offer. The first client computer 120 can be configured to rescind the task offer before it is accepted by the second client computer 150.

In an exemplary embodiment, the system 100 can include an escrow account, and the server 130 can be configured to transfer the task offer amount of electronic currency from the transaction database 140 to the escrow account. In an exemplary embodiment, the server 130 can be configured to transfer back the task offer amount of electronic currency from the escrow account to the transaction database 140, if the second client computer 150 rejects the task offer.

An escrow account, as used herein, can be a financial instrument held by a third party (e.g. the server 130) on behalf of two other parties (e.g. the first client computer 120 and the second client computer 150) that are in the process of completing a transaction. The electronic currency 125 can be held in the escrow account until predetermined contractual obligations have been fulfilled (e.g. completion of the task associated with the offer).

In an exemplary embodiment, the first client computer 120 can be configured to create the first electronic message 115 in a human readable format on a user interface, which can enable a user to readily and rapidly access the first electronic message 115. The human readable format can be a representation of data or information that can be naturally read by humans. For example, the human readable format can be encoded as ASCII or Unicode text, or any equivalents thereof.

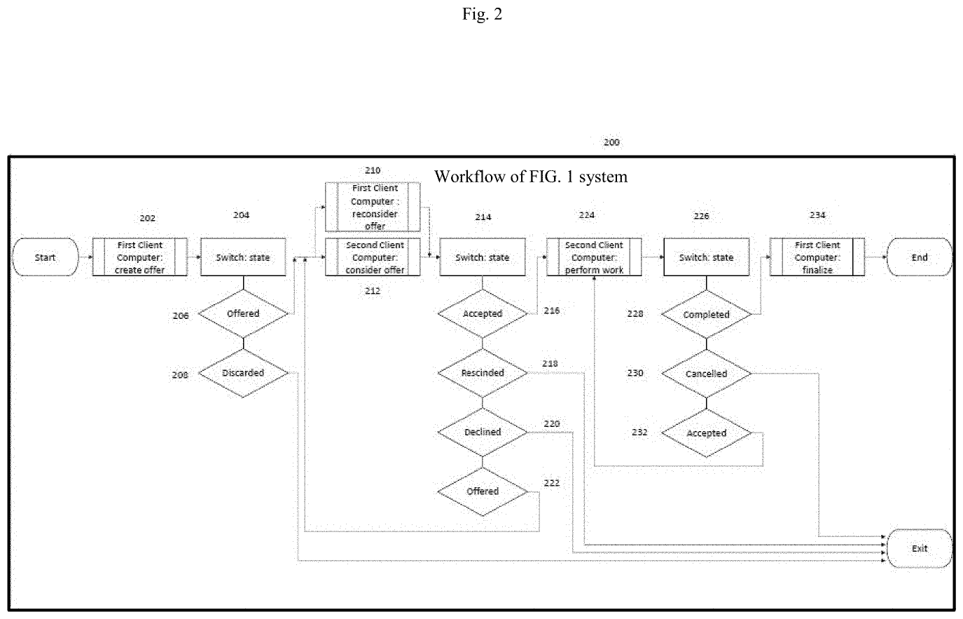

FIG. 2 illustrates a workflow 200 for assessing task priority via electronic currency communication within a network, which can be implemented on the system 100 of FIG. 1. In an exemplary embodiment, the workflow 200 can include creating a task offer 202 by the first client computer 120. The workflow 200 can include a switch state 204 with an offered state 206 and a discarded state 208. At the offered state 206, the task offer 202 can be extended to the second client computer 150. At the discarded state 208, the task offer 202 is discarded and the workflow 200 terminates.

In an exemplary embodiment of the workflow 200, the first client computer 120 can rescind the task offer 218 before it is accepted by the second client computer 150. When the task offer 202 is extended to the second client computer 150, the second client computer 150 can consider whether to accept, decline, or renegotiate the task offer 212. If the second client computer 150 declines the task offer 220, the workflow 200 terminates. If the second client computer 150 renegotiates the task offer, the renegotiated task offer information 222 is sent back to the first client computer 120, as shown in FIG. 2.

In an exemplary embodiment of the workflow 200, the second client computer 150 can accept the task offer 216. After accepting the task offer 202, the second client computer 150 can execute one or more sub-tasks associated with the task offer 224. As a result, the second client computer 150 can complete the execution of the task 228. Alternatively, the second client computer 150 can cancel the execution of the task 230 before it is completed, which can result in the termination of the workflow 200, as shown in FIG. 2.

In an exemplary embodiment, after completing the sub-task associated with the task offer, the second client computer 150 can communicate with the first client computer 120. The first client computer 120 can confirm whether all the sub-tasks have been successfully completed and finalize the transaction 234.

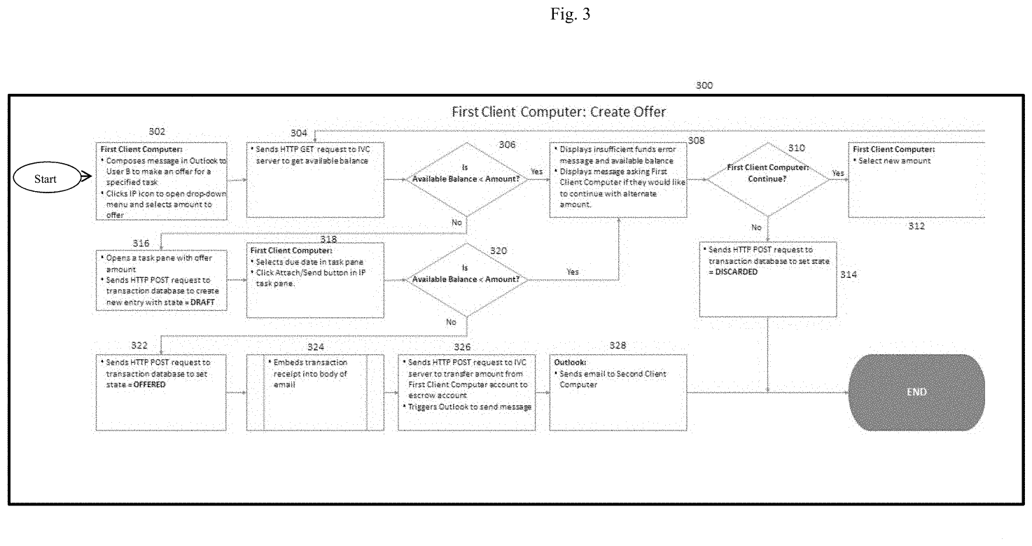

FIG. 3 illustrates a workflow 300 that is a detailed version of creating an offer 202 by the first client computer 120. In an exemplary embodiment, the first client computer 120 can compose a message in an electronic application (e.g., Outlook or instant messenger) 302 to be directed to the second client computer 150 with task information. The task information, including a task amount, can be input by typing it in on a user interface, or by selecting the information from a drop-down menu of the electronic application, or by using a touch screen user interface. Application of a “user interface”, as used in this disclosure, includes the previously described ways of inputting information (e.g., typing, selecting on a drop-down menu, or using a touch screen), or any equivalents thereof.

In an exemplary embodiment, the first client computer 120 can send an application protocol request 304 (e.g., HTTP GET request) to the server 130 to receive available balance information of the electronic currency 125. The assessment module 132 of the server 130 can check whether the available balance of the electronic currency 125 is less than the task offer amount 306. If the available balance is less than the task offer amount, the first client computer 120 can display an insufficient funds error message on a user interface with the amount of available balance of the electronic currency 125 and/or display a message on a user interface asking whether a user would prefer to continue with an alternate amount of electronic currency 125 or abort the transaction 308, as shown in FIG. 3.

If the available balance is less than the task offer amount, the first client computer 120 can ask a user whether to continue or terminate the transaction 310. If the user of the first client computer 120 decides to continue, the first client computer can ask the user to select a new amount 312 on a user interface. If the user of the first client computer 120 decides not to continue, the first client computer 120 can terminate the transaction. The transaction can be terminated by sending an application protocol request 314 (e.g., HTTP POST request) to discard the transaction, as shown in FIG. 3.

In an exemplary embodiment, if the available balance of the electronic currency 125 is greater than or the task offer amount, the first client computer 120 can launch an electronic application on a user interface with a task pane containing the task offer amount, among other task information, and can send an application protocol request (e.g. HTTP POST request) to the transaction database 140 to create a new entry for a task associated with the task offer amount 316, as shown in FIG. 3.

In an exemplary embodiment, the task pane can include task information, which can include multiple sub-tasks describing respective steps of the task. The launched task pane can display one or more of the sub-tasks on the user interface in response to communication with an input device (e.g. mouse, keyboard, etc.), or a touch screen input. The task pane can include a reference pane with selectable reference information tabs, each of the reference information tabs being related to the displayed sub-tasks.

In an exemplary embodiment, the first client computer 120 can select a due date for completion of the task in the task pane, and the task pane can include an attach/send button to allow a user of the first client computer 120 to send a message in an electronic application (e.g. Outlook or Instant Messenger) 318. After selecting a due date, the first client computer can check whether the available balance is greater than or equal to the task offer amount 320 by sending a protocol request (e.g. HTTP POST) 322 to the transaction database 140, as shown in FIG. 3.

In an exemplary embodiment, if the available balance is greater than or equal to the task amount the first client computer 120 can embed a transaction receipt in the body of the message being sent by the electronic application 324. In some instances, the format of the embedded transaction receipt can include a standard format that may be read by a variety of applications. As such, the embedded transaction receipt can be an image and/or a file that is application independent.

In an exemplary embodiment, the first client computer 120 can send an application protocol request (e.g. HTTP POST) to the server 130 to transfer the task offer amount from an account associated with the first client computer 120 to an escrow account 326. This can trigger sending a message in an electronic application (e.g. Outlook or Instant messenger) to the second client computer 150 regarding the offer by the first client computer 328, as shown in FIG. 3.

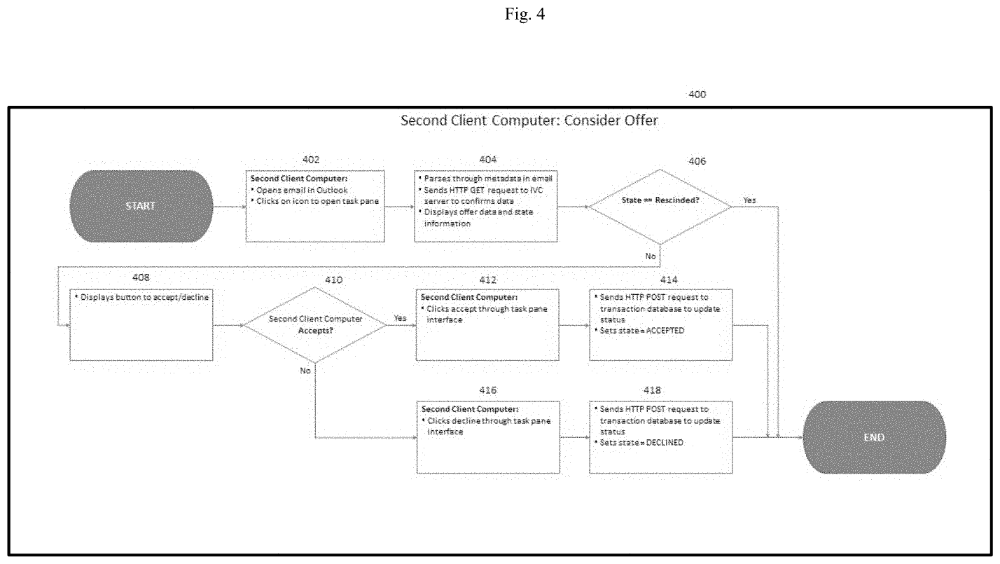

FIG. 4 illustrates a workflow 400 that is a detailed version of the second client computer 150 considering a task offer 212. In an exemplary embodiment, the second client computer 150 can open the received message in an electronic application (e.g., Outlook or Instant Messenger) by clicking an icon (e.g., a star and/or an emoji) to open a task pane 402.

In an exemplary embodiment, the second client computer 150 can parse through metadata embedded in the received message, and then send an application protocol request (e.g., HTTP GET) to the server 130 to confirm the data. The second client computer 150 can also display the task offer data after parsing through metadata embedded in the received message, as shown in FIG. 4.

In an exemplary embodiment, the second client computer 150 can check whether the task offer by the first client computer is still valid or has been rescinded 406. If the task offer has been rescinded, the workflow 400 can terminate. If the offer is still valid, the second client computer 150 can display options to accept or decline the task offer 408 on a task pane of a user interface. If the second client computer 150 declines the task offer, it can send an application protocol request (e.g., HTTP POST) to the transaction database 140 to request funds be returned from the escrow account 418 and terminate the workflow 400. If the second client computer 150 declines the task offer and funds have not been returned from escrow, the first computer can send an application protocol request (e.g., HTTP POST) to the transaction database 140 to request funds be returned from the escrow account 418. If the second client computer 150 accepts the task offer, it can send an application protocol request (e.g., HTTP POST) to the transaction database 140 to keep the funds in escrow until the task is complete 414, as shown in FIG. 4.

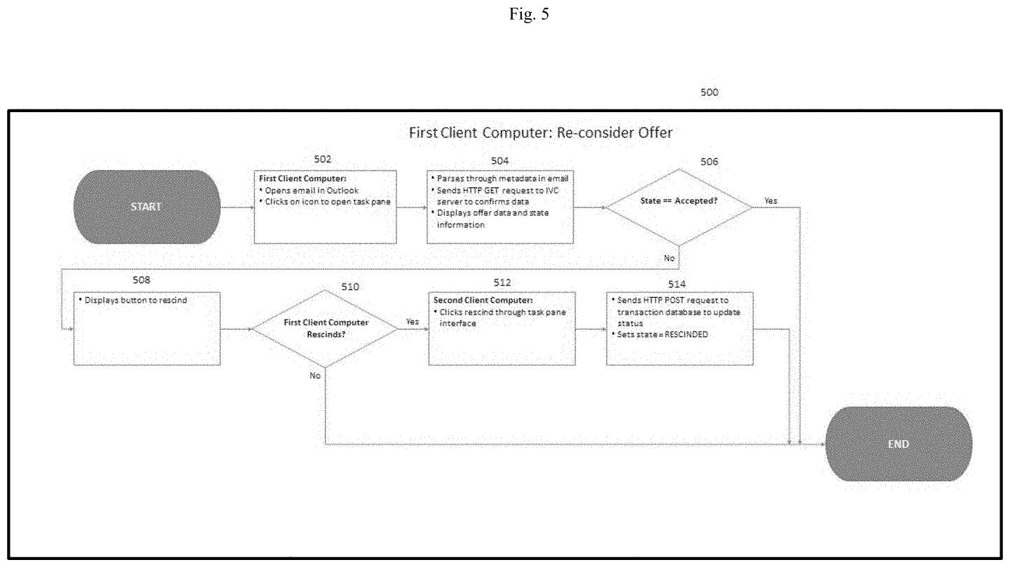

FIG. 5 illustrates a workflow 500 that is a detailed version of the first client computer 120 re-considering a task offer 210 before it is accepted by the second client computer 150. In an exemplary embodiment, the first client computer 120 can click an icon (e.g., a star and/or an emoji) to launch an electronic application (e.g., Outlook or Instant Messenger) and open a task pane 502. The first client computer 120 can parse through metadata of a message in the electronic application; send an application protocol request (e.g., HTTP GET) to the server 130 to confirm information in the message; and display task offer information 504 at a user interface. If the task offer has been accepted by the second client computer 150, the workflow 500 terminates.

In an exemplary embodiment, if the message in the electronic application shows a state that the task offer has not been accepted by the second client computer 150, a task pane at a user interface can display an option (e.g., a selecting button) to rescind the task offer 508. If the first client computer 120 does not rescind the task offer, the workflow 500 terminates 510. If the first client computer 120 rescinds the task offer, the first client computer 120 can send an application layer protocol request to the transaction database 140 to request funds back from the escrow account 514 and terminate the workflow 500, as shown in FIG. 5.

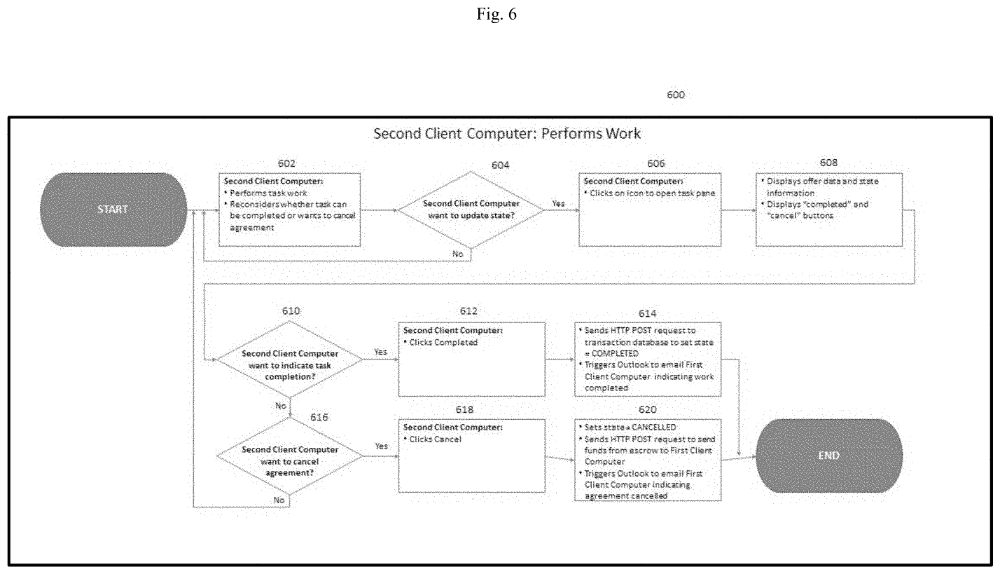

FIG. 6 illustrates a workflow 600 that is a detailed version of the second client computer 150 performing a task 224. In an exemplary embodiment, at any time during the performing of a task the second client computer 150 can reconsider whether the task can be completed, whether the task can be completed on time, or whether a user of the second client computer 150 would like to cancel the task transaction agreement 602. In such cases, the second client computer 150 can display a task pane on a user interface to display offer data and state information of a task 608. The second client computer 150 can also display task status buttons (e.g., “completed” or “canceled”) 608 on a task pane of a user interface.

In an exemplary embodiment, if the second client computer 150 completes the task, the second client computer 150 can select the “completed” button 612 on a task pane of a user interface. In such a case, the second client computer 150 can send an application protocol request (e.g., HTTP POST) to the transaction database 140 to indicate that the task has been completed, and send an electronic message (e.g., Outlook message or Instant Messenger) to the first client computer 120 communicating that the task has been completed 614.

In an exemplary embodiment, if the second client computer 150 wants to cancel the task transaction agreement, the second client computer 150 can select the “cancel” button 618 on a task pane of a user interface. In such a case, the second client computer 150 can send an application protocol request (e.g., HTTP POST) to the transaction database 140 to indicate that the task transaction agreement has been canceled, and send an electronic message (e.g., Outlook message or Instant Messenger) to the first client computer 120 communicating that the task transaction agreement has been canceled 620 and performance of the task terminated prior to completion.

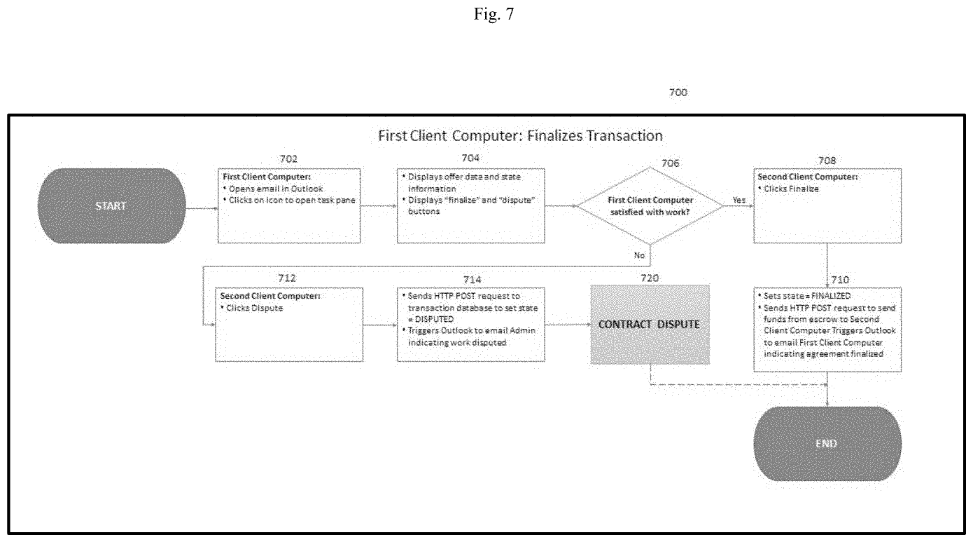

FIG. 7 illustrates a workflow 700 that is a detailed version of finalizing a transaction 234. In an exemplary embodiment, the first client computer 120 can launch an electronic message (e.g., Outlook or Instant Messenger) and click on an icon to launch a task pane 702. The task pane can display offer data and information of the state of the performance of the task with finalize and dispute button selections 704. The first client computer 120 can review the completion of the task as communicated by the second client computer 150.

In an exemplary embodiment, if the first client computer 120 is satisfied with the completion of the task 706, the second client computer 150 can select the finalize button on the task pane 708. The second client computer 150 can then send an application protocol request (e.g., HTTP POST) to request to send funds from escrow account to an account associated with the second client computer 120. The second client computer 150 can launch an electronic message (e.g., Outlook or Instant Messenger) to inform the first client computer 120 that the task transaction agreement has been finalized 710.

In an exemplary embodiment, if the first client computer 120 is not satisfied with the completion of the task 706, the second client computer 150 can select the dispute button on the task pane 712. The second client computer 150 can then send an application protocol request (e.g., HTTP POST) to the transaction database 140 to indicate a dispute 714. The second client computer 150 can launch an electronic message (e.g., Outlook or Instant Messenger) to inform an administrator of the system 100 that there is a task transaction agreement dispute 720.

A person having ordinary skill in the art would appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, one or more of the disclosed modules can be a hardware processor device with an associated memory.

A hardware processor device as discussed herein may be a single hardware processor, a plurality of hardware processors, or combinations thereof. Hardware processor devices may have one or more processor “cores.” The term “non-transitory computer readable medium” as discussed herein is used to generally refer to tangible media such as a memory device.

Various embodiments of the present disclosure are described in terms of an exemplary computing device. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Hardware processor, as used herein, may be a special purpose or a general purpose processor device. The hardware processor device may be connected to a communications infrastructure, such as a bus, message queue, network, multi-core message-passing scheme, etc. An exemplary computing device, as used herein, may also include a memory (e.g., random access memory, read-only memory, etc.), and may also include one or more additional memories. The memory and the one or more additional memories may be read from and/or written to in a well-known manner. In an embodiment, the memory and the one or more additional memories may be non-transitory computer readable recording media.

Data stored in the exemplary computing device (e.g., in the memory) may be stored on any type of suitable computer readable media, such as optical storage (e.g., a compact disc, digital versatile disc, Blu-ray disc, etc.), magnetic tape storage (e.g., a hard disk drive), or solid-state drive. An operating system can be stored in the memory.

In an exemplary embodiment, the data may be configured in any type of suitable database configuration, such as a relational database, a structured query language (SQL) database, a distributed database, an object database, etc. Suitable configurations and storage types will be apparent to persons having skill in the relevant art.

The exemplary computing device may also include a communications interface. The communications interface may be configured to allow software and data to be transferred between the computing device and external devices. Exemplary communications interfaces may include a modem, a network interface (e.g., an Ethernet card), a communications port, a PCMCIA slot and card, etc. Software and data transferred via the communications interface may be in the form of signals, which may be electronic, electromagnetic, optical, or other signals as will be apparent to persons having skill in the relevant art. The signals may travel via a communications path, which may be configured to carry the signals and may be implemented using wire, cable, fiber optics, a phone line, a cellular phone link, a radio frequency link, etc.

Memory semiconductors (e.g., DRAMs, etc.) may be means for providing software to the computing device. Computer programs (e.g., computer control logic) may be stored in the memory. Computer programs may also be received via the communications interface. Such computer programs, when executed, may enable computing device to implement the present methods as discussed herein. In particular, the computer programs stored on a non-transitory computer-readable medium, when executed, may enable hardware processor device to implement the methods illustrated by FIGS. 2 and 4, or similar methods, as discussed herein. Accordingly, such computer programs may represent controllers of the computing device.

Where the present disclosure is implemented using software, the software may be stored in a computer program product or non-transitory computer readable medium and loaded into the computing device using a removable storage drive or communications interface.

In an exemplary embodiment, any computing device disclosed herein can also include a display interface that outputs display signals to a display unit, e.g., LCD screen, plasma screen, LED screen, DLP screen, CRT screen, etc.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

What is claimed is:

1. A system for enhancing efficiency of an enterprise network via electronic currency communication within the enterprise network, the system comprising:
a first client computer configured to create a first electronic message, wherein the first electronic message includes at least a task offer electronic currency amount and one or more task attributes of an executable task;
a transaction database configured to store electronic currency;
a server configured to receive the first electronic message from the first client computer, wherein the server includes an assessment module and an embedding module, the assessment module being configured to perform an assessment as to whether there is an available balance of the electronic currency for the task offer electronic currency amount by accessing the transaction database, and the embedding module being configured to embed the task attributes and/or the task offer electronic currency amount as metadata in the first electronic message, based on the assessment of the available balance of the electronic currency;
a second client computer configured to receive the first electronic message containing the metadata from the server, parse the first electronic message containing the metadata to obtain a task offer associated with the executable task, and determine whether to accept the task offer, wherein the server includes a reallocation module configured to reallocate network resources based on at least one of first client computer behavior data, second client computer behavior data, timestamp data, network topology data, network transactions data, or network traffic data to enhance the efficiency of the enterprise network.

2. The system of claim 1, wherein the first client computer behavior data includes at least one of utility information that indicates utility of the task offer amount for the first client computer, motivation information that indicates a preference of the task attributes for the first client computer, or priority information that indicates a priority of the first client computer for transmitting a request for the executable task in relation to transmitting requests for other tasks.

3. The system of claim 1, wherein the second client computer behavior data includes at least one of utility information that indicates utility of the task offer amount for the second client computer, motivation information that indicates a preference of the task attributes for the second client computer, or priority information that indicates a priority of the second client computer for performing the executable task in relation to performing other tasks.

4. The system of claim 1, wherein the timestamp data include at least one of a time of the time a first electronic message is created, the time the server receives the first electronic message, the time the second client computer receives the first electronic message containing the metadata, the time the second client computer transmits a second electronic message responding to the offer, the time the first client computer receives the second electronic message, the time the second client computer completes the executable task, or the time the second client computer transmits a third electronic message notifying the server or the first client computer the executable task has been completed.

5. The system of claim 1, wherein the network topology data include a physical arrangement of the first client computer, the second client computer, and the server, and a logical arrangement for data flow among the first client computer, the second client computer, and the server.

6. The system of claim 1, wherein the network transactions data include probability distribution statistics based on transactions between the first client computer, the second client computer, and the server.

7. The system of claim 1, wherein the network traffic data includes a rate of data flow among the first client computer, the second client computer, and the server at a specific time.

8. The system of claim 1, wherein the second client computer is configured to transmit a second electronic message to the first client computer upon completion of the executable task.

9. The system of claim 2, wherein the first client computer is configured to rate the completion of the executable task.

10. The system of claim 1, wherein the first client computer is configured to launch an electronic application to modify the task attributes.

11. The system of claim 6, wherein the first client computer is configured to modify the task attributes in the electronic application by selecting or changing a due date for completing the executable task.

12. The system of claim 1, wherein the server is configured to terminate the task offer when the available balance is less than the task offer electronic currency amount.

13. The system of claim 1, wherein the server is configured to terminate the task offer when the second client computer rejects the offer.

14. The system of claim 1, wherein the first client computer is configured to rescind the task offer prior to the second client computer accepting the task offer.

15. The system of claim 1, comprising:
an escrow account, wherein the server is configured to transfer the task offer electronic currency amount from the transaction database to the escrow account.

16. The system of claim 11, wherein the server is configured to transfer back the task offer amount from the escrow account to the transaction database, when the second client computer rejects the offer.

17. The system of claim 1, wherein the first client computer is configured to create the first electronic message in a human readable format on a user interface.

18. The system of claim 1, comprising:
a distributed ledger configured to record one or more of the first client computer behavior data, the second client computer behavior data, the timestamp data, the network topology data, the network transactions data, the network traffic data, the task offer electronic currency amount, or the task attributes.

19. A computerized method for enhancing efficiency of an enterprise network via electronic currency communication within the enterprise network, the method comprising:
creating a first electronic message at a first client computer, wherein the first electronic message includes at least a task offer electronic currency amount and one or more task attributes of an executable task;
storing electronic currency at a transaction database by the first client computer;
transmitting the first electronic message from the first client computer to a server;
performing, at the server, an assessment as to whether there is an available balance of the electronic currency for the task offer electronic currency amount by accessing the transaction database;
embedding, at the server, the task attributes and/or the task offer electronic currency amount as metadata in the first electronic message, based on the assessment of the available balance of the electronic currency;
transmitting the first electronic message containing the metadata to a second client computer;
parsing, at the second client computer, the first electronic message containing the metadata to obtain a task offer associated with the executable task and determining whether to accept the task offer; and
reallocating, by the server, network resources based on at least one of first client computer behavior data, second client computer behavior data, timestamp data, network topology data, network transactions data, or network traffic data to enhance the efficiency of the enterprise network.

20. The method of claim 19, comprising:
transmitting a second electronic message from the second client computer to the first client computer upon completion of the executable task, when the second client computer accepts the offer.
